(19) United States
(12) Patent Application Publication
(10) Pub. No.: US 2025/0383456 A1
(43) Pub. Date: Dec. 18, 2025

(54) POSITION INFORMATION CALCULATION APPARATUS, POSITION INFORMATION CALCULATION METHOD, AND PROGRAM

(71) Applicant: NIPPON TELEGRAPH AND TELEPHONE CORPORATION, Tokyo (JP)

(72) Inventors: Kotaro ONO, Tokyo (JP); Kazuhiro TOKUNAGA, Tokyo (JP); Takeshi KUWAHARA, Tokyo (JP)

(21) Appl. No.: 18/878,753

(22) PCT Filed: Jul. 4, 2022
(86) PCT No.: PCT/JP2022/026629

§ 371 Date: Dec. 24, 2024

(51) Int. Cl. G01S 19/43; B60W 60/00

(52) U.S. Cl. CPC G01S 19/43; B60W 60/001; B60W 2556/50

(57) ABSTRACT

A position information calculation device calculates position information of a positioning target by using observation data of a reference station, and includes an acquiring unit that acquires reference station information and position information of the positioning target from a database, and a position information calculating unit that selects a reference station having a shortest base line length with the positioning target on the basis of the reference station information and the position information, and calculates the position information of the positioning target using a positioning calculation technique according to the base line length.

### TECHNICAL FIELD

The present invention relates to a technique of acquiring position information.

### BACKGROUND ART

In recent years, positioning by global navigation satellite systems (GNSS) has been used for a wide range of applications including smartphones.

Real Time Kinematic (RTK) positioning, which is one of GNSS positioning technique, is widely used alone or in combination with a dead reckoning technique. The RTK positioning is a technique of performing positioning calculation using observation data (raw data) at a reference station and observation data at an unknown point (positioning target) in real time.

### CITATION LIST

### Non Patent Literature

Non Patent Literature 1: “Implementation of Automatic Travel between Agricultural Fields and Remote Monitoring Control of Agricultural Machinary by Robotic Agricultural Machines, 5G, and IOWN-Related Technology”, NTT Technical Journal, 2021.3, https://journal.ntt.co.jp/wp-content/uploads/2021/03/JN202103115.pdf

### SUMMARY OF INVENTION

### Technical Problem

However, in the RTK positioning of the related art, there is a problem that the positioning accuracy may deteriorate due to a long base line length, a failure in timely switching between single-frequency RTK and double-frequency RTK, and the like.

The present invention has been made in light of the above-described points, and it is an object of the present invention to provide a technique of avoiding a decrease in positioning accuracy and realizing highly accurate positioning in RTK positioning.

### Solution to Problem

According to the disclosed technology, provided is a position information calculation device that calculates position information of a positioning target by using observation data of a reference station, and includes:
an acquiring unit that acquires reference station information and position information of the positioning target from a database; and
a position information calculating unit that selects a reference station having a shortest base line length with the positioning target on the basis of the reference station information and the position information, and calculates the position information of the positioning target using a positioning calculation technique according to the base line length.

### Advantageous Effects of Invention

According to the disclosed technology, provided is a technology of avoiding a decrease in positioning accuracy and realizing highly accurate positioning in RTK positioning.

### BRIEF DESCRIPTION OF DRAWINGS

FIG. 1 is a diagram illustrating an overall configuration example of a system.

FIG. 2 is a configuration diagram of a position information calculation device 100.

FIG. 3 is a diagram for explaining an operation sequence.

FIG. 4 is a diagram illustrating an example of a case in which information of an NW state is used for positioning calculation.

FIG. 5 is a flowchart illustrating an operation of position information calculating unit 140.

FIG. 6 is a diagram illustrating an example of an unmanned transport system based on position information.

FIG. 7 is a diagram illustrating a system configuration example.

FIG. 8 is a diagram illustrating a hardware configuration example of a device.

### DESCRIPTION OF EMBODIMENTS

Hereinafter, an embodiment of the present invention (present embodiment) will be described with reference to the drawings. An embodiment to be described below is merely exemplary, and an embodiment to which the present invention is applied are not limited to the following embodiment. Note that “/” used in the following description means “or”. However, a case in which the context clearly dictates otherwise is except.

For example, “A/B” means “A or B”. However, “A/B” does not mean “only one of A and B”, and “both A and B” is also included in the meaning of “A/B”.

In an example to be described below, single-frequency RTK and double-frequency RIK are used, but RTK using signals of three or more frequencies such as triple or more-frequency RTK may be used.

Information stored in each database to be described below is constantly (for example, periodically) updated. That is, information such as an NW state (transmission delay or the like), reference station information, and position information of a terminal (positioning target), which are obtained in real time, are constantly updated and stored in each database described below.

Note that the existing positioning calculation technique described below is a known technique, but description of features thereof, analysis, description of problems, or the like are not known techniques.

### DESCRIPTION OF PROBLEM

### <Existing RTK Positioning>

First, a mechanism of RTK positioning (including decision of integer ambiguity=initialization), a cause of a decrease in positioning accuracy, and a relationship between a reference station and a mobile station (in particular, information exchange and transmission paths) will be described.

### (1) Double-Frequency RTK

In double-frequency RTK in which an L2 signal is also used for single-frequency RTK in which only an L1 signal is used, since an ionospheric delay can be corrected by a difference in frequency between the L1 signal and the L2 signal, it is possible to reduce an initialization time and improve positioning accuracy in a case in which the base line length is long.

On the other hand, in a case in which the base line length is short, not a bias error caused by the ionospheric delay but a random error caused by multipath or the like becomes a dominant factor, and thus, the accuracy of the double-frequency RTK is lower than that of the single-frequency RTK.

### (2) Reference Station Switching

As the reference station is switched in accordance with handover between base stations to which a mobile terminal is connected, data of the reference station closest to the mobile terminal is used for RTK positioning. Therefore, it is possible to reduce the initialization time and improve the positioning accuracy.

However, the above-described switching is based on the assumption that the base station is the reference station, and the reference station used for the RTK positioning needs not be necessarily the closest reference station (for example, the reference station having the shortest base line length). An ionospheric delay, a tropospheric delay, a satellite orbital error, and the like related to calculation increase depending on the distance (base line length) between the reference station and the mobile terminal. Therefore, the longer the base line length, the lower the positioning accuracy. However, the related art does not support the timely switching of the double-frequency/single-frequency RTK according to the base line length.

(3) Correction of Satellite Clock Bias based on Transmission Delay

In the process of the positioning calculation of the related art, positioning accuracy can be improved by considering a transmission delay as a fixed amount. However, the related art does not support a mobile terminal in which the NW environment changes from moment to moment.

### <Overview of Problems and Solutions>

In the related art, when a GNSS signal received by a terminal is interrupted even for a moment, initialization is performed each time, and thus, it transitions to point positioning or RTK float, leading to a decrease in the positioning accuracy. A time taken to transition to RTK Fix again (=initialization time (TTFF)) is on the order of tens of even in an environment with good visibility (which may be on the order of several minutes or more depending on an environment). Therefore, it is necessary to shorten the TTFF.

In the RTK positioning, it is assumed that the errors related to the GNSS signals received by the reference station and the mobile terminal are common at the same time. The ionospheric delay, the tropospheric delay, the satellite orbital error, and the like related to calculation changes depending on the distance (base line length) between the reference station and the mobile terminal. That is, the longer the base line length, the lower the positioning accuracy.

Further, even in a case in which the base line length is short, when transmission and reception of the GNSS signal received by the mobile terminal and the reference station via the NW are included in the process related to calculation, an error occurs in a time axis related to the calculation due to the NW delay, and thus, there is a possibility that the positioning accuracy decreases.

Higher accuracy and ultra-higher real-time capabilities are required for automatic driving and other applications.

In the present embodiment, a position information calculation device 100 to be described later performs the following operations (1) to (4) to solve the problems and improve the accuracy of the RTK positioning calculation.

The GNSS signal received by each reference station is stored in a reference station database via the NW, and NW information is stored in an NW information database.

(1) The position information calculation device 100 selects a reference station having the shortest base line length with the mobile terminal at the time of RTK positioning calculation on the basis of an updated database (the reference station and the position information).

(2) The position information calculation device 100 selects the single-frequency RTK or the double-frequency RTK in accordance with the base line length of the selected reference station.

(3) The position information calculation device 100 collects an NW state that can affect accuracy in positioning calculation.

(4) The position information calculation device 100 estimates an initial position necessary for high-accuracy RTK positioning of the mobile terminal on the basis of the NW information.

As described above, the accuracy of the RTK positioning calculation is improved by switching of single-frequency RTK/double-frequency RTK, selecting the reference station having the shortest base line length, and utilizing the NW information such as the transmission delay information. Although all of the operations are used in the embodiment, all of the operations need not be necessarily used in the invention, and at least one of the operations may be used.

With the above-described operations, it is possible to perform switching between the single-frequency/double-frequency RTK in accordance with the environment of the terminal, and it is possible to realize higher real-time capabilities with ultra-high accuracy.

### OVERVIEW OF EMBODIMENT

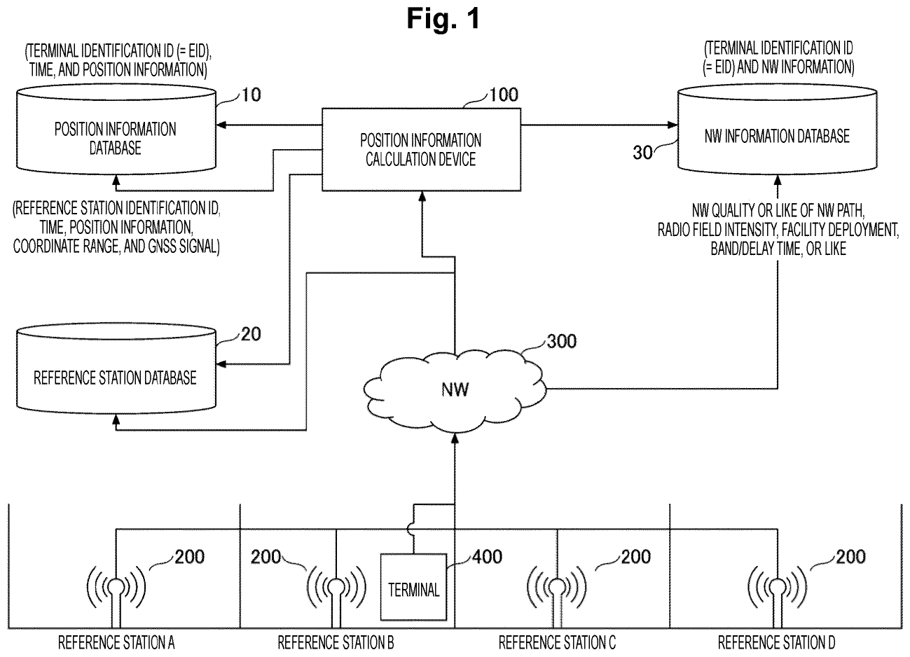

FIG. 1 illustrates an overview configuration of a system according to the present embodiment. As illustrated in FIG. 1, a position information calculation device 100, a position information database 10, a reference station database 20, and an NW information database 30 are provided on a network (NW) 300. Further, there are a moving terminal 400 and reference stations 200 (A to D).

Any or all of the position information database 10, the reference station database 20, and the NW information database 30 may be a database (storage unit) in the position information calculation device 100. Further, although FIG. 1 illustrates an image in which positioning calculation is performed on the NW side, functions of the position information calculation device 100 may be provided on the terminal side (GNSS receiver side).

A process of optimizing RTK positioning for a terminal serving as a positioning target using the NW information in the configuration of FIG. 1 will be described.

### <S0>

The GNSS signal (raw data) received by each reference station 200 is stored in the reference station database 20 via the NW 300. The NW information is stored in the NW information database 30.

The reference station database 20 stores a reference station identification ID, time, position information, a coordinate range, and a GNSS signal for each reference station. The “coordinate range” is a range of positions at which the reference station becomes the closest reference station.

The NW information database 30 stores a terminal identification ID (=EID) and NW information for each terminal. The NW information is an NW quality or the like of an NW path, radio field intensity, facility deployment, a band/delay time, or the like for the terminal.

### <S1>

First, in S1, the terminal 400 establishes a connection to the NW 300. Here, the terminal identification ID (EID) is assigned to the terminal 400, and the terminal 400 starts transmitting the GNSS signal and the EID received by itself to the position information calculation device 100 via the NW 300.

### <S2>

In S2, the position information calculation device 100 estimates the position (initial position) of the terminal 400 at a certain time on the basis of the NW information. This estimation can be performed, for example, by using a time difference of arrival (TDOA)-based terminal location estimation technology according to the 3GPP standard specification. The NW information in the case of using this terminal position estimation technology is, for example, a signal propagation period of time between the terminal 400 and a plurality of base stations.

### <S3>

In S3, the position information calculation device 100 stores the initial position estimated in S2 in the position information database 10. When it is difficult to calculate the position information on the basis of the GNSS signal, the position information is complemented on the basis of the NW information. The position information database 10 stores a terminal identification ID (=EID), time, and position information for each terminal.

### <S4>

In S4, the position information calculation device 100 decides the reference station used for the RTK positioning and a positioning calculation technique (double-frequency/single-frequency) on the basis of the time and the position information of the terminal 400 stored in each database and the known reference station position.

### <S5>

In S5, the position information calculation device 100 decides a transmission delay to be considered (delay related to transmission of the GNSS signal) on the basis of either or both of the NW information between itself and the terminal 400 and the NW information between itself and the reference station.

### <S6>

In S6, the position information calculation device 100 calculates the position information of the terminal 400 on the basis of S4 and S5, and stores the position information in the position information database 10. Thereafter, S4 to S6 are repeated.

### (Detailed Device Configuration and Process Sequence)

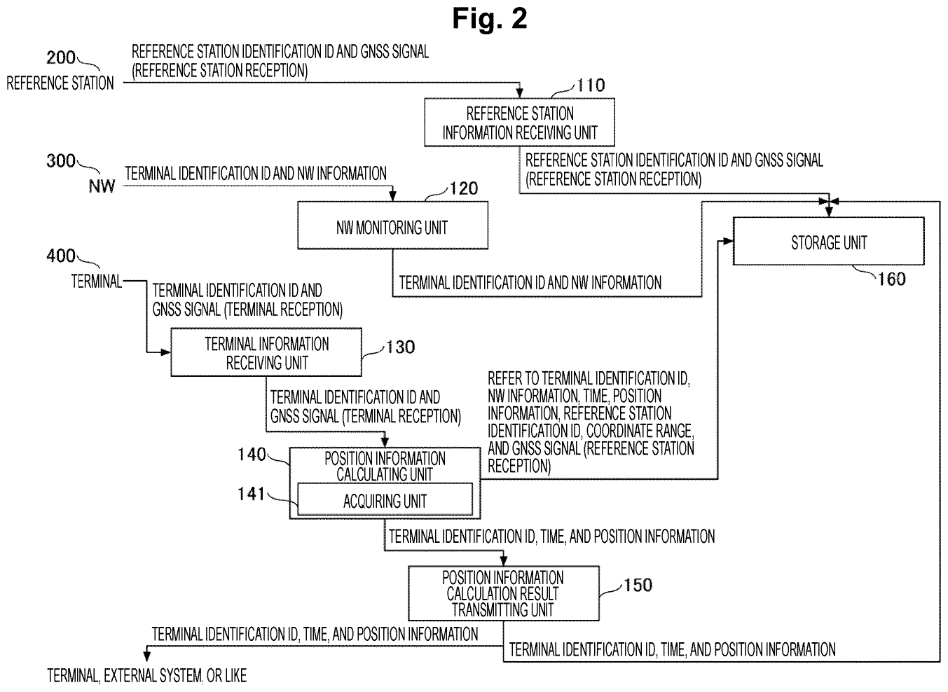

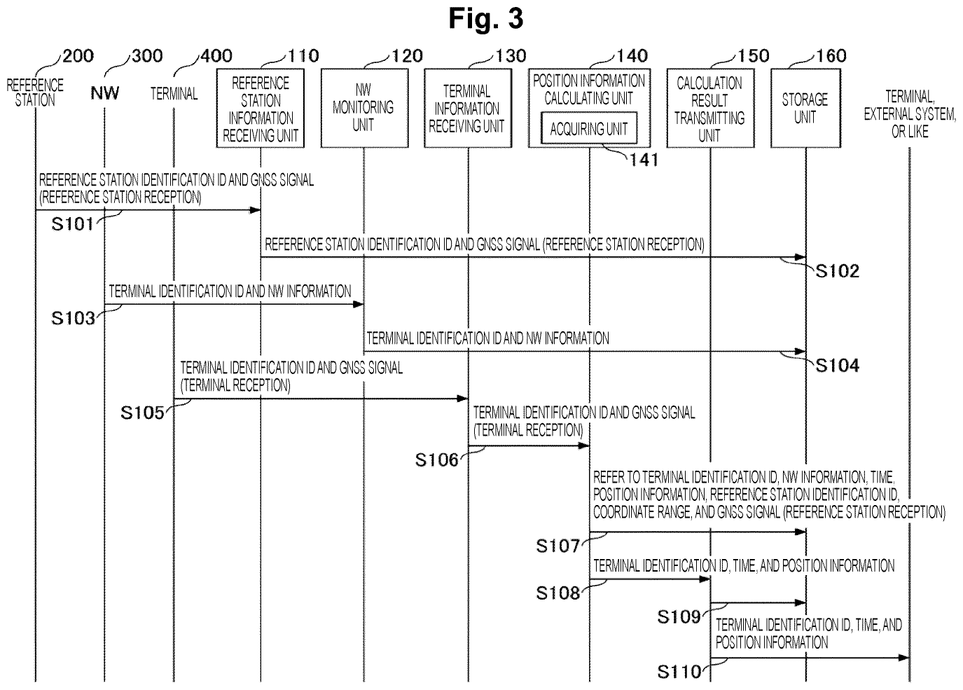

FIG. 2 illustrates a configuration example of the position information calculation device 100 according to the present embodiment. Transmission and reception of information between function units will be described later with reference to FIG. 3. Further, the position information calculation device 100 may be referred to as a position information calculation system. The position information calculation device 100 may be implemented by one computer (server) or may be implemented by a plurality of computers.

As illustrated in FIG. 2, the position information calculation device 100 includes a reference station information receiving unit 110, an NW monitoring unit 120, a terminal information receiving unit 130, a position information calculating unit 140, a calculation result transmitting unit 150, and a storage unit 160. The storage unit 160 corresponds to the position information database 10, the reference station database 20, and the NW information database 30 described above. The storage unit 160 may be provided outside the position information calculation device 100.

Further, the position information calculating unit 140 includes an acquiring unit 141 that acquires information from the storage unit 160. The acquiring unit 141 may be installed outside the position information calculating unit 140.

Information transmission and reception between function units and the like will be described with reference to FIG. 3. In S101, the reference station information receiving unit 110 receives the reference station identification ID and the GNSS signal (reference station reception) transmitted from the reference station 200. In S102, the reference station information receiving unit 110 stores (transmits) the reference station identification ID and the GNSS signal (reference station reception) in the storage unit 160.

The NW monitoring unit 120 receives, in S103, the terminal identification ID and the NW information from the NW 300, and stores, in S104, the terminal identification ID and the NW information in the storage unit 160. In S105, the terminal information receiving unit 130 receives the terminal identification ID and the GNSS signal (terminal reception) from the terminal 400, and notifies the position information calculating unit 140 of the terminal identification ID and the GNSS signal (terminal reception) in S106.

In S107, the position information calculating unit 140 refers to (acquires) the terminal identification ID, the NW information, the time, the position information, the reference station identification ID, the coordinate range, and the GNSS signal (reference station reception) from the storage unit 160.

The position information calculating unit 140 calculates time and position information of the terminal 400 on the basis of the information received from the terminal 400 and the information acquired from the storage unit 160.

In S108, the position information calculating unit 140 notifies the calculation result transmitting unit 150 of the terminal identification ID, the time, and the position information. The calculation result transmitting unit 150 stores the terminal identification ID, the time, and the position information in the storage unit 160, and transmits the terminal identification ID, the time, and the position information to the terminal, an external system, or the like (S109 and S110).

### (Delay Time Calculation and Positioning Calculation Functions)

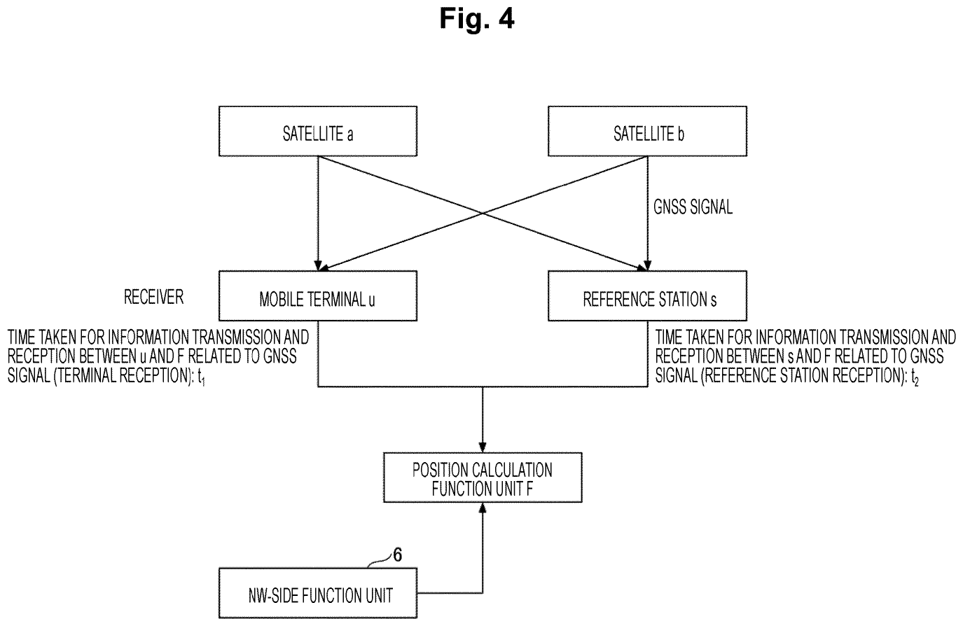

Next, delay time calculation and positioning calculation functions will be described. As illustrated in FIG. 4, a situation in which there are satellites a and b, a terminal u (receiver serving as a positioning target), and a reference station s is assumed. Further, a positioning calculation function unit F and an NW-side function unit 6 are provided. Further, a configuration including the satellites a and b, the terminal u, and the reference station s illustrated in FIG. 4, and a method of calculating a carrier wave phase observation value @ and a double phase difference of a carrier wave phase which will be described below using a mathematical formula are disclosed in “https://www.denshi.e.kaiyodai.ac.jp/kubo/isejima.pdf”.

A time (for example, a signal propagation period of time from u to F) taken for transmission and reception of information between u and F related to the GNSS signal (terminal reception) is indicated by t₁, and a time (for example, a signal propagation period of time from s to F) taken for transmission and reception of information between s and F related to the GNSS signal (reference station reception) is indicated by t₂. An information transmission/reception time difference is obtained by Δt=t₂−t₁.

In the NW-side function unit 6, Δt obtained by state monitoring of the NW/server resources is notified to F and used for positioning calculation. That is, a system that utilizes the NW information is implemented.

The carrier wave phase observation value @ is expressed as follows.

$$Φ = ρ + c ( d t - dT ) - I + T \times λ N + ε$$

The meanings of the respective symbols are as follows.
Φ: carrier wave phase (m)
ρ: geometric distance (m) between satellite and receiver
c: speed of light (m/s)
dt: receiver clock error(s)
dT: satellite clock error(s)
I: ionospheric delay amount (m)
T: tropospheric delay amount (m)
λ: wavelength (m)
N: carrier wave phase bias (cycle)
ε: noise (m)

The double phase difference of the carrier wave phase is expressed as follows.

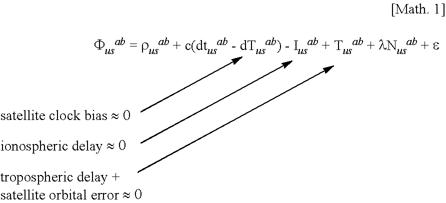

Satellite clock correction (when t₂>t₁) is calculated as follows.

$${\overline{ϕ}}_{s}^{a} ( t ) ( carrier wave phase after estimation ) = {ϕ}_{s}^{a} ( t - Δ t ) - {ca}_{f 1}^{a} Δ t \qquad [ Math . 2 ]$$

$${\overline{P}}_{s}^{a} ( t ) ( pseudo distance after estimation ) = {P}_{s}^{a} ( t - Δ t ) - {ca}_{f 1}^{a} Δ t$$

$$Δ t = {t}_{2} - {t}_{1} : information transmission / reception time difference$$

$${a}_{f 1}^{a} : first - order term of GNSS satellite clock correction coefficient$$

In the present embodiment, a portion of Δt is varied in real time. That is, the delayed result can be reflected in the positioning calculation function unit F.

The positioning calculation function unit F of FIG. 4 corresponds to the position information calculating unit 140 of the position information calculation device 100. The positioning calculation function unit F may be a terminal-side function or may be an NW-side function. The NW-side function unit 6 corresponds to, for example, the NW monitoring unit 120 of the position information calculation device 100.

That is, the NW monitoring unit 120 calculates Δt and notifies the position information calculating unit 140 of Δt. The NW monitoring unit 120 may calculate Δt and store Δt in the storage unit 160 (database), and the position information calculating unit 140 may read Δt from the storage unit 160. The position information calculating unit 140 executes the calculations represented by Math. 1 and Math. 2.

Further, the NW monitoring unit 120 may store the transmission delays (t₁ and t₂) in the storage unit 160 (database), and the position information calculating unit 140 may read the transmission delays (t₁ and t₂) from the storage unit 160 to calculate Δt and perform calculation of the position information using Δt.

### (Processing Procedure of Position Information Calculating Unit 140)

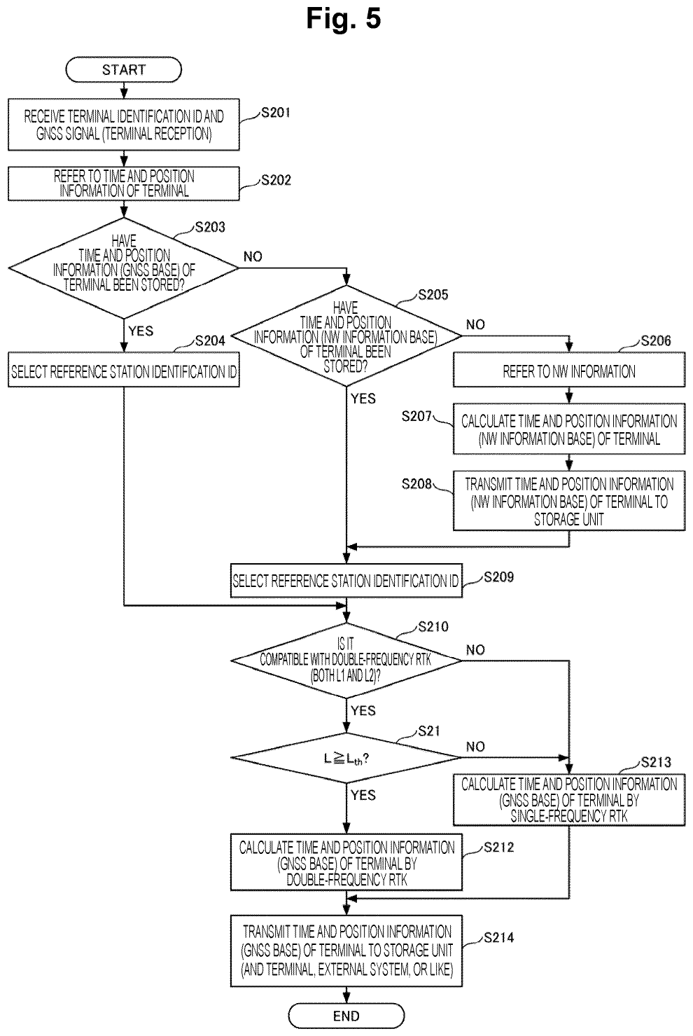

Next, an example of a processing procedure of the position information calculating unit 140 will be described with reference to a flowchart of FIG. 5. In S201, the position information calculating unit 140 receives the terminal identification ID and the GNSS signal (terminal reception) from the terminal information receiving unit 130. In S202, the position information calculating unit 140 refers to, on the basis of the terminal identification ID, the time and the position information of the terminal 400 stored in the storage unit 160. In S203, the position information calculating unit 140 checks whether the time and the position information (GNSS base) of the terminal 400 have been stored in the storage unit 160. If the determination result of S203 is Yes, the process proceeds to S204, and if the determination result of S203 is No, the process proceeds to S205.

In S204, the position information calculating unit 140 refers to the reference station identification ID and the coordinate range stored in the storage unit 160, and selects the reference station identification ID to be used for the calculation of the time and the position information (GNSS base) on the basis of the time and the position information (GNSS base) of the terminal 400. That is, the terminal 400 is located in the coordinate range (the range of the position at which the reference station is the closest reference station), and the reference station having the shortest base line length with the terminal 400 is selected as the reference station. Subsequently, the case of selecting the reference station identification ID is similar. After S204, the process proceeds to S210.

In S205, the position information calculating unit 140 checks whether the time and the position information (NW information base) of the terminal 400 have been stored in the storage unit 160. If the determination result of S205 is Yes, the process proceeds to S209, and if the determination result of S205 is No, the process proceeds to S206.

In S206, the position information calculating unit 140 refers to, on the basis of the terminal identification ID, the NW information stored in the storage unit 160.

In S207, the position information calculating unit 140 calculates the time and the position information (NW information base) of the terminal 400 on the basis of the NW information.

In S208, the position information calculating unit 140 transmits the time and the position information (NW information base) of the terminal 400 to the storage unit 160.

In S209, the position information calculating unit 140 refers to the reference station identification ID, the time, the position information, the coordinate range, and the GNSS signal stored in the storage unit 160, and selects the reference station identification ID to be used for the calculation of the time and the position information (GNSS base) on the basis of the time and the position information (NW information base) of the terminal 400.

In S210, the position information calculating unit 140 determines whether the GNSS signal (terminal reception) received from the terminal information receiving unit 130 is compatible with the double-frequency RTK (both L1 and L2) or not. If the determination result of S210 is Yes, the process proceeds to S211, and if the determination result of S210 is No, the process proceeds to S213.

In S211, the position information calculating unit 140 determines whether “L≥Lₜₕ” is satisfied or not. If the determination result of S211 is Yes, the process proceeds to S212, and if the determination result of S211 is No, the process proceeds to S213. Here, L is a distance (base line length) between the terminal 400 and the reference station 200, and Lₜₕ is a threshold value at which the double-frequency RTK positioning is better in accuracy than the single-frequency RTK positioning.

In S212, the position information calculating unit 140 refers to the NW information stored in the storage unit 160 on the basis of the terminal identification ID, and calculates the time and the position information (GNSS base) of the terminal 400 by the double-frequency RTK in consideration of the NW information.

In S213, the position information calculating unit 140 refers to the NW information stored in the storage unit 160 on the basis of the terminal identification ID, and calculates the time and the position information (GNSS base) of the terminal 400 by the single-frequency RTK in consideration of the NW information.

In S214, the position information calculating unit 140 transmits the time and the position information (GNSS base) of the terminal 400 to the storage unit 214, and transmits the time and the position information (GNSS base) of the terminal 400 to the terminal, an external system, or the like.

### (Example of Unmanned Transport System Based on Position Information)

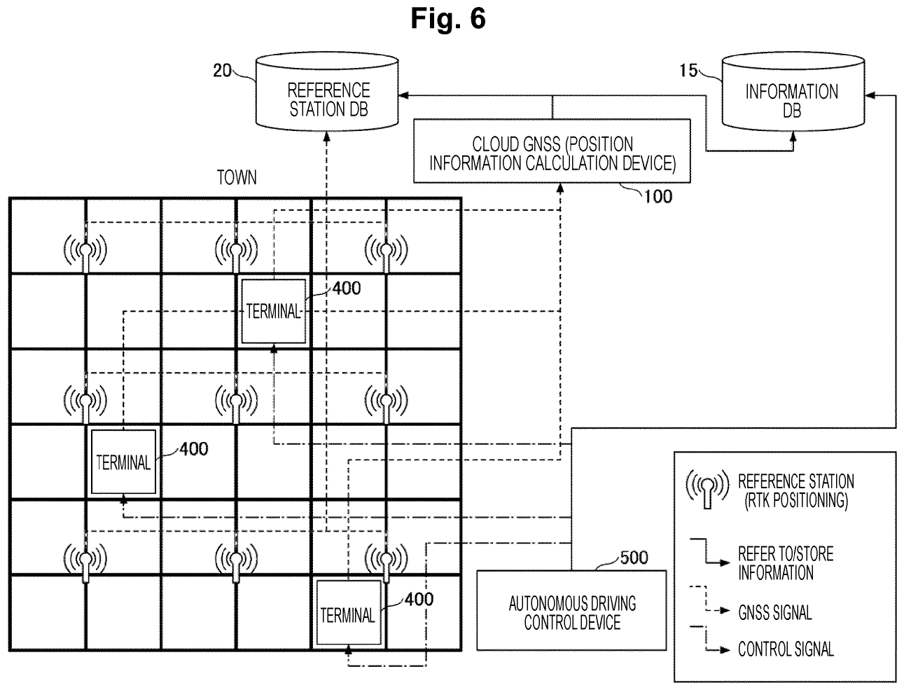

The position information calculation device 100 capable of appropriately calculating the position information of the terminal 400 in a situation in which the closest reference station and the NW transmission delay depending on terminal movement change can be applied to various fields. Here, as an example, an example of an unmanned transport system based on highly accurate position information of the terminal by the RTK positioning will be described with reference to FIG. 6.

Here, the position information calculation device 100 is provided as a function of a cloud GNSS. Further, provided is an autonomous driving control device 500 that performs control (example: stop and deceleration) on the terminal 400 on the basis of the position information of the terminal 400 (autonomous vehicle or the like).

The autonomous driving control device 500 may be an independent device, a function unit in the position information calculation device 100, or a function unit in the terminal 400.

As illustrated in FIG. 6, a reference station DB 20 and an information DB 15 are provided. The information DB 15 corresponds to the position information DB 10 and the NW information DB 30.

It is assumed that terminal 400 moves in an area (town) composed of 6×6=36 squares, which include a plurality of reference stations 200.

The position information calculation device 100 performs the positioning calculation of the terminal 400 on the basis of the GNSS signal reception result (raw data) transmitted from the terminal 400 and the GNSS signal reception result (raw data and reference station data) in the reference station 200, and stores the position information of the terminal 400 serving as the calculation result in the information DB 15. The autonomous driving control device 500 performs automatic driving control on the terminal 400 with reference to the position information of the terminal 400 in the information DB 15.

### (Configuration Example of System)

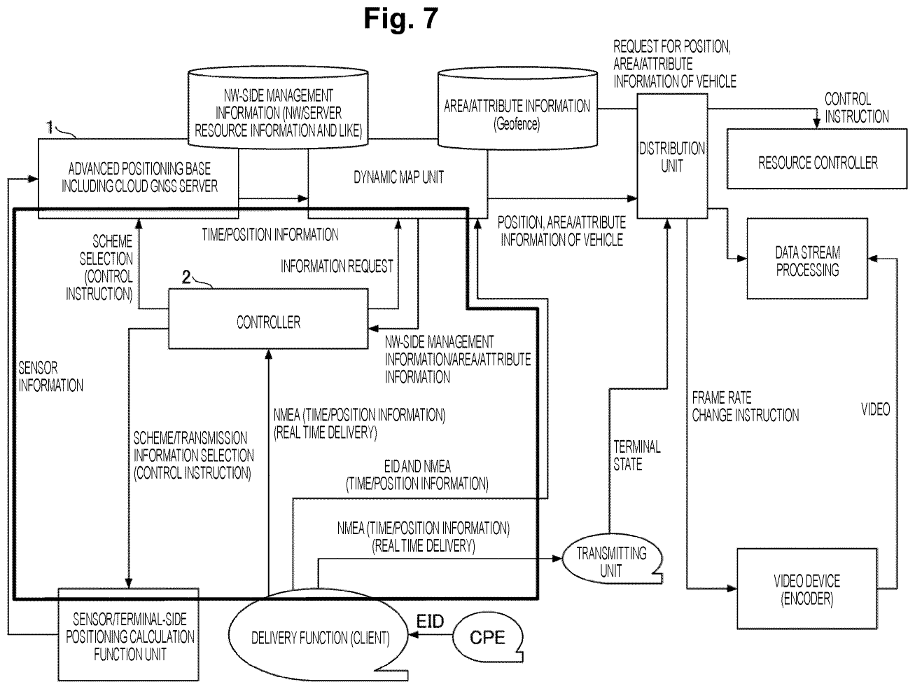

The position information calculation device 100 described in the present embodiment may be used in a position information distribution base illustrated in FIG. 7. An advanced positioning base 1 in FIG. 7 may have the function of the position information calculation device 100, a controller 2 may have the function of the position information calculation device 100, or the function of the position information calculation device 100 may be implemented by both the advanced positioning base 1 and the controller 2.

Further, FIG. 7 illustrates an example of controlling a video transmitted by a vehicle as an example. As abbreviations illustrated in FIG. 7, NW is an abbreviation for network, EID is an abbreviation for Endpoint Identifierm, CPE is an abbreviation for Customer Premises Equipment, NMEA is an abbreviation for NMEA 0183, and NMEA itself is an abbreviation for National Marine Electronics Association.

### (Hardware Configuration Example)

The position information calculation device 100 can be implemented, for example, by causing a computer to execute a program in which processing content described in the present embodiment is described. This computer may be a physical computer, or may be a virtual machine on a cloud.

That is, the position information calculation device 100 can be implemented by executing a program corresponding to the process performed in the device using hardware resources such as a CPU and a memory built in the computer. The program can be stored or distributed after being recorded on a computer-readable recording medium (portable memory or the like). The program can also be provided through a network such as the Internet or an electronic mail.

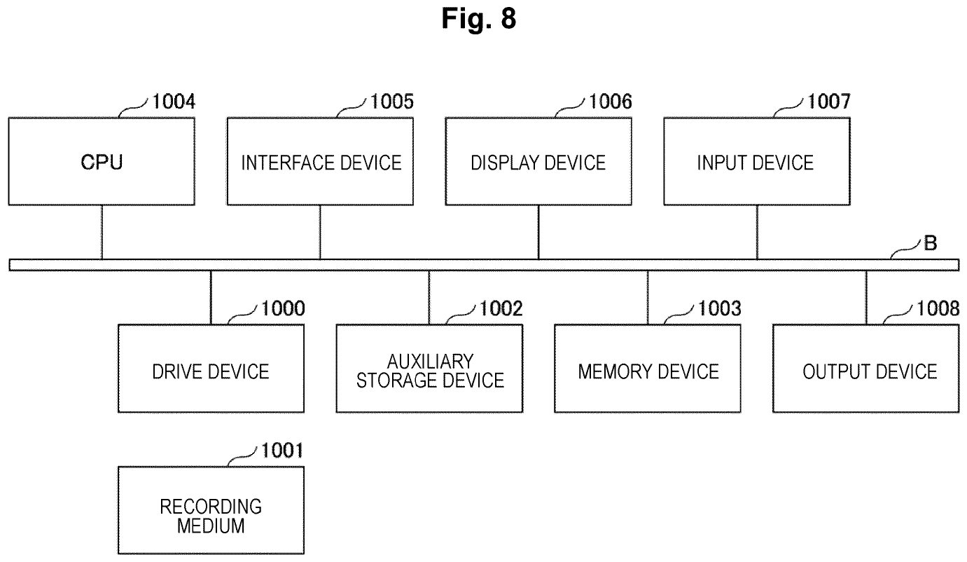

FIG. 8 is a diagram illustrating a hardware configuration example of the computer. The computer of FIG. 8 includes a drive device 1000, an auxiliary storage device 1002, a memory device 1003, a CPU 1004, an interface device 1005, a display device 1006, an input device 1007, an output device 1008, and the like, which are connected to each other via a bus BS.

The program of implementing a process in the computer is provided through a recording medium 1001 such as a CD-ROM or a memory card, for example. When the recording medium 1001 storing the program is set in the drive device 1000, the program is installed in the auxiliary storage device 1002 from the recording medium 1001 via the drive device 1000. However, the program needs not necessarily installed from the recording medium 1001, and may be downloaded from another computer via a network. The auxiliary storage device 1002 stores the installed program and also stores necessary files, data, and the like.

In a case where an instruction to start the program is given, the memory device 1003 reads the program from the auxiliary storage device 1002 and stores the program. The CPU 1004 implements a function related to the control device 100 in accordance with the program stored in the memory device 1003. The interface device 1005 is used as an interface for connection to a network of the like. The display device 1006 displays a graphical user interface (GUI) or the like according to the program. The input device 1007 is configured with a keyboard and a mouse, a button, a touch panel, or the like, and is used to input various operation instructions. The output device 1008 outputs a calculation result.

### Conclusion and Effects of Embodiments

The position information calculation device 100 according to the present embodiment selects the reference station having the shortest base line length with the terminal 400 serving as the positioning target at the time of RTK positioning calculation on the basis of the database (the reference station and the position information) updated each time. Therefore, since the GNSS signal of the closest reference station can be used, the initialization time can be shortened, and the positioning accuracy is improved.

Further, the position information calculation device 100 selects the single-frequency RTK or the double-frequency RTK in accordance with the base line length of the selected reference station. Therefore, it is possible to improve the accuracy by considering the ionospheric delay according to the change in the base line length accompanying the terminal movement.

Further, the position information calculation device 100 collects and utilizes the NW state that may affect the accuracy in the positioning calculation involving transmission and reception of the GNSS signal reception result via the NW. Therefore, the NW state connected to the mobile terminal/reference station that changes from moment to moment can be reflected in the positioning calculation, and the accuracy can be improved.

Further, the position information calculation device 100 estimates the initial position necessary for high-accuracy RTK positioning of the mobile terminal on the basis of the NW information. Therefore, the initial position estimation on the terminal side becomes unnecessary, and the transmission of the initial position estimation result from the terminal to the upper side via the NW becomes unnecessary. As a result, simplification of the terminal can be implemented.

Further, when it is difficult to calculate the position information on the GNSS basis, the position information calculation device 100 can calculate the position information on the basis of the NW information and complement the position information. Therefore, it is possible to implement a flexible operation in which weighting of the position information and multi-stage fail safe are combined.

### (Supplementary Notes)

With regard to the embodiment described above, the following supplementary notes are further disclosed.

### (Supplementary Note 1)

A position information calculation device that calculates position information of a positioning target by using observation data of a reference station, the position information calculation device including:
an acquiring unit that acquires reference station information and position information of the positioning target from a database; and
a position information calculating unit that selects a reference station having a shortest base line length with the positioning target on the basis of the reference station information and the position information, and calculates the position information of the positioning target using a positioning calculation technique according to the base line length.

### (Supplementary Note 2)

The position information calculation device according to Supplementary Note 1, wherein
the positioning calculation technique is single-frequency RTK or double-frequency RTK, and the position information calculating unit calculates the position information of the positioning target using the double-frequency RTK when the base line length is equal to or longer than a threshold value.

### (Supplementary Note 3)

The position information calculation device according to Supplementary Note 1 or 2, wherein the acquiring unit acquires transmission delay information of the observation data from the database, and the position information calculating unit calculates the position information of the positioning target using the transmission delay information.

### (Supplementary Note 4)

The position information calculation device according to any one of Supplementary Notes 1 to 3, wherein the acquiring unit acquires NW information from the database, and the position information calculating unit calculates an initial position of the positioning target in the positioning calculation technique using the NW information.

### (Supplementary Note 5)

The position information calculation device according to any one of Supplementary Notes 1 to 4, wherein the position information calculating unit calculates position information to be used for performing automatic driving control for the positioning target.

### (Supplementary Note 6)

A position information calculation method executed by a position information calculation device that calculates position information of a positioning target by using observation data of a reference station, the position information calculation method including:
an acquisition step of acquiring reference station information and position information of the positioning target from a database; and
a position information calculation step of selecting a reference station having a shortest base line length with the positioning target on the basis of the reference station information and the position information, and calculating the position information of the positioning target using a positioning calculation technique according to the base line length.
   (Supplementary note 7)

A non-transitory storage medium storing a program causing a computer to function as the respective units in the position information calculation device according to any one of Supplementary Notes 1 to 5.

Although the present embodiment has been described above, the present invention is not limited to specific embodiments, and various modifications or changes can be made within the scope of accompanying claims.

### REFERENCE SIGNS LIST

10 Position information database
20 Reference station database
30 NW information database
100 Position information calculation device
110 Reference station information receiving unit
120 NW monitoring unit
130 Terminal information receiving unit
140 Position information calculating unit
141 Acquiring unit
150 Calculation result transmitting unit
160 Storage unit
200 Reference station
300 NW
400 Terminal
500 Autonomous driving control device
1000 Drive device
1001 Recording medium
1002 Auxiliary storage device
1003 Memory device
1004 CPU
1005 Interface device
1006 Display device
1007 Input device
1008 Output device

1. A position information calculation apparatus for calculating position information of a positioning target by using observation data of a reference station, the position information calculation apparatus comprising:
circuitry configured to:
acquire reference station information and position information of the positioning target from a database,
select the reference station with a shortest baseline length to the positioning target, based on the reference station information and the position information, and
calculate the position information of the positioning target using a positioning calculation technique according to the baseline length.

2. The position information calculation apparatus according to claim 1, wherein the positioning calculation technique is single-frequency real time kinematic (RTK) or double-frequency RTK, and
wherein the circuitry is configured to calculate the position information of the positioning target using the double-frequency RTK when the baseline length is equal to or longer than a threshold value.

3. The position information calculation apparatus according to claim 1, wherein the circuitry is configured to acquire transmission delay information of the observation data from the database, and calculate the position information of the positioning target using the transmission delay information.

4. The position information calculation apparatus according to claim 1, wherein the circuitry is configured to acquire network (NW) information from the database, and calculate an initial position of the positioning target in the positioning calculation technique using the NW information.

5. The position information calculation apparatus according to claim 1, wherein the circuitry is configured to calculate the position information to be used for automatic driving control of the positioning target.

6. A position information calculation method executed by a position information calculation apparatus for calculating position information of a positioning target by using observation data of a reference station, the position information calculation method comprising:
acquiring reference station information and position information of the positioning target from a database;
selecting the reference station with a shortest baseline length to the positioning target, based on the reference station information and the position information; and
calculating the position information of the positioning target using a positioning calculation technique according to the baseline length.

7. A non-transitory computer readable storage medium storing a program causing a computer to execute the position information calculation method of claim 6.
